(19) United States
(12) Patent Application Publication
(10) Pub. No.: US 2022/0013261 A1
(43) Pub. Date: Jan. 13, 2022

(54) METHOD FOR MASS-MANUFACTURING OF MINIATURE RESISTOR

(71) Applicant: Ralec Electronic Corporation, Kaohsiung (TW)

(72) Inventor: Tim WANG, Kaohsiung (TW)

(21) Appl. No.: 17/109,703

(22) Filed: Dec. 2, 2020

(30) Foreign Application Priority Data
Jul. 7, 2020 (TW) 109122884

(51) Int. Cl. H01C 17/00

(52) U.S. Cl. CPC H01C 17/003

(57) ABSTRACT

A method for mass-manufacturing of a miniature resistor includes the steps of: providing a foil sheet; forming intersecting rows of slits to define a patterned foil sheet having a matrix array of resistor blanks that are interconnected at intersections of the intersecting rows; forming first and second photoresist films on the patterned foil sheet; forming holes in the first photoresist film; forming protruding blocks to fill the holes; removing the first and second photoresist films; encapsulating the patterned foil sheet and the protruding blocks without covering outer surfaces of the protruding blocks; performing a cutting process to obtain individual resistor blanks; and forming two external electrodes respectively on the protruding blocks and on two side surfaces of the individual resistor blank to obtain the miniature resistor.

### CROSS-REFERENCE TO RELATED APPLICATION

This application claims priority of Taiwanese Patent Application No. 109122884, filed on Jul. 7, 2020.

### FIELD

The present disclosure relates to a method for manufacturing a passive electronic component, and more particularly to a method for mass-manufacturing of a miniature resistor.

### BACKGROUND

Referring to FIG. 1, among one of the passive electronic components widely used in various electronic devices to implement a predetermined electrical resistance is a miniature resistor 100, which includes a resistor blank 11 made of an electrically conductive material, a supporting layer 12 disposed on a bottom surface of the resistor blank 11, an encapsulating layer 13 covering the resistor blank 11 and the supporting layer 12, and two external electrodes 14 formed on two opposite side surfaces of the resistor blank 11.

A conventional method for mass-manufacturing of the miniature resistor 100 basically involves first preparing a plate made of an electrically conductive material and then disposing the supporting sheet 12 on a bottom surface of the plate. Thereafter, the plate is subjected to a cutting process to form a plurality of resistor blanks 11 arranged in a matrix array, followed by subjecting a top surface of each of the resistor blanks 11 to a resistance trimming process so as to provide a predetermined resistance value to the resistor blanks 11. Subsequently, an insulating layer 13 is disposed to cover the resistor blanks 11, and then the resistor blanks 11 are again subjected to the cutting process or an etching process to obtain individual resistor blanks 11 that are separated from one another. Finally, two external electrodes 14 are formed on two opposite side surfaces of each of the individual resistor blanks 11, thereby obtaining a plurality of the miniature resistors 100.

The aforementioned conventional method for mass-manufacturing of the miniature resistor 100 has various shortcomings such as, deformation of the resistor blank 11 and difficulty in obtaining high precision during the cutting process, the packaging being sticky or resin overflow, the external electrodes 14 having uneven thickness or insufficient density if formed by plating, and other technical issues. Therefore, those in the industry endeavor to solve the abovementioned and related technical issues by proposing various solutions as exemplified by Taiwanese Invention Patent Publications Nos. I438787, I553672, I600354, etc., and at the same time protecting their manufacturing process and products.

With advancement in the development of electronic products, the requirements for application of miniature resistors therein have become more diverse, and thus, one of the key focuses for those skilled in the art is to continuously propose various manufacturing procedures so as to provide more options and to solve the various technical problems encountered in mass-manufacturing of miniature resistors.

### SUMMARY

Therefore, an object of the present disclosure is to provide a method for mass-manufacturing of a miniature resistor that can alleviate at least one of the drawbacks of the prior art.

According to the present disclosure, the method for mass-manufacturing of the miniature resistor includes the steps of:

(A) providing a foil sheet made of an electrically conductive material having a predetermined resistance value;

(B) forming a plurality of slits penetrating through the foil sheet and arranged in multiple longitudinal and transverse rows so as to define a patterned foil sheet, the patterned foil sheet including a plurality of resistor blanks arranged in a matrix array, a plurality of connecting regions situated at intersections of the longitudinal and transverse rows, and a framing strip that loops around the resistor blanks, the slits and the connecting regions, the slits aligned in each of the longitudinal and transverse rows being spaced apart from each other at intersections of the longitudinal and transverse rows, the resistor blanks being connected to each other by the connecting regions and the framing strip;

(C) bonding a first photoresist film and a second photoresist film respectively to a top surface and a bottom surface of the patterned foil sheet so as to cover the resistor blanks;

(D) forming a plurality of holes in the first photoresist film such that the holes expose top surfaces of the resistor blanks;

(E) forming a plurality of protruding blocks made of an electrically conductive material that has a predetermined resistance value in the holes such that the protruding blocks filling the holes are connected to the top surfaces of the resistor blanks;

(F) removing the first photoresist film and the second photoresist film from the patterned foil sheet so as to expose the resistor blanks;

(G) encapsulating the patterned foil sheet and the protruding blocks using an encapsulating material such that the encapsulating material covers the top and bottom surfaces of the resistor blanks without covering outer surfaces of the protruding blocks;

(H) performing a cutting process to remove parts of the encapsulating material extending along intersecting cutting lines passing through the slits, the connecting regions and the framing strip so as to obtain a plurality of individual resistor blanks that are separated from one another; and

(I) forming two external electrodes respectively on the protruding blocks and on two opposite side surfaces of each of the individual resistor blanks so as to obtain the miniature resistor.

### BRIEF DESCRIPTION OF THE DRAWINGS

Other features and advantages of the present disclosure will become apparent in the following detailed description of the embodiments with reference to the accompanying drawings, of which:

FIG. 1 is a sectional perspective view illustrating a conventional miniature resistor;

FIG. 2 is a flow chart illustrating the consecutive steps of an embodiment of a method for mass-manufacturing of a miniature resistor according to the present disclosure;

FIG. 3 is a sectional perspective view illustrating the miniature resistor manufactured by the embodiment;

FIG. 4 is a fragmentary schematic view illustrating a patterned foil sheet formed by the method;

FIG. 5 is a schematic view illustrating a step of forming a plurality of slits to define the patterned foil sheet, in which the patterned foil sheet includes a plurality of resistor blanks;

FIG. 6 is a schematic view illustrating a step of bonding photoresist films on the patterned foil sheet which is performed after the step shown in FIG. 5;

FIG. 7 is a schematic view illustrating three consecutive steps of forming a plurality of holes, forming a plurality of protruding blocks and removing the photoresist films which are performed after the step shown in FIG. 6;

FIG. 8 is a schematic view illustrating a sub-step of trimming top surfaces of the resistor blanks and a consecutive step of encapsulating the patterned foil sheet and the protruding blocks which are performed after the steps shown in FIG. 7; and

FIG. 9 is a schematic view illustrating two consecutive steps of performing a cutting process to obtain individual resistor blanks and forming external electrodes so as to obtain the miniature resistor which are performed after the steps shown in FIG. 8.

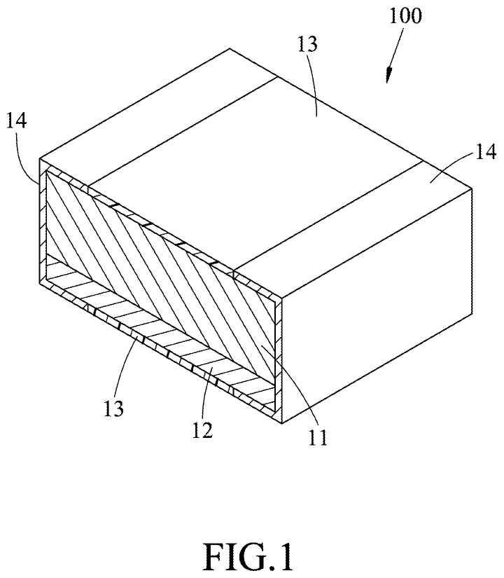

### DETAILED DESCRIPTION

Before the present disclosure is described in greater detail, it should be noted that where considered appropriate, reference numerals or terminal portions of reference numerals have been repeated among the figures to indicate corresponding or analogous elements, which may optionally have similar characteristics.

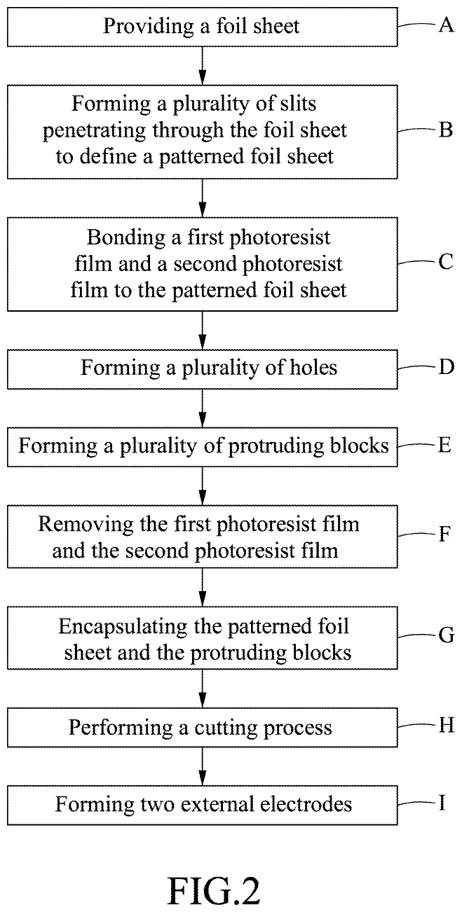

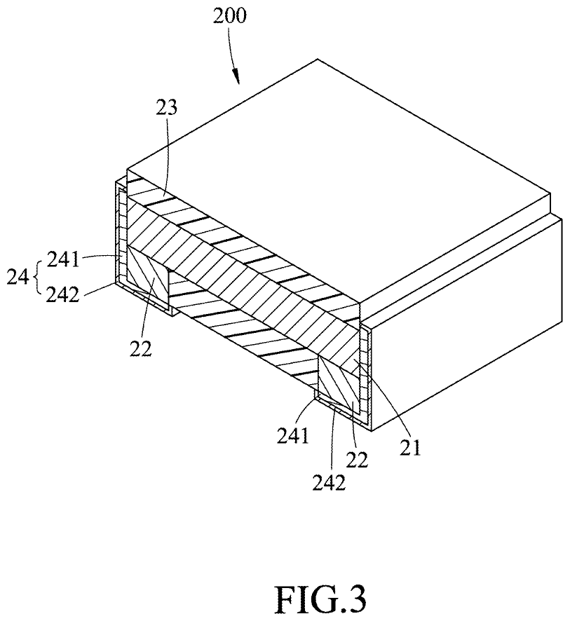

Referring to FIGS. 2 and 3, a method for mass-manufacturing of a miniature resistor 200 according to an embodiment of the present disclosure includes steps (A) to (I).

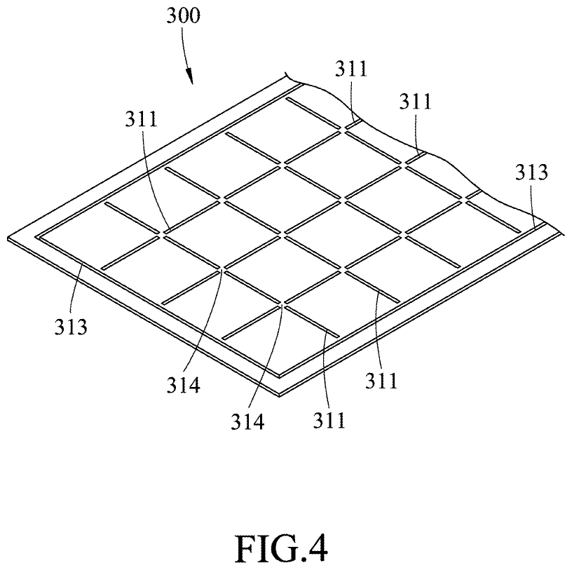

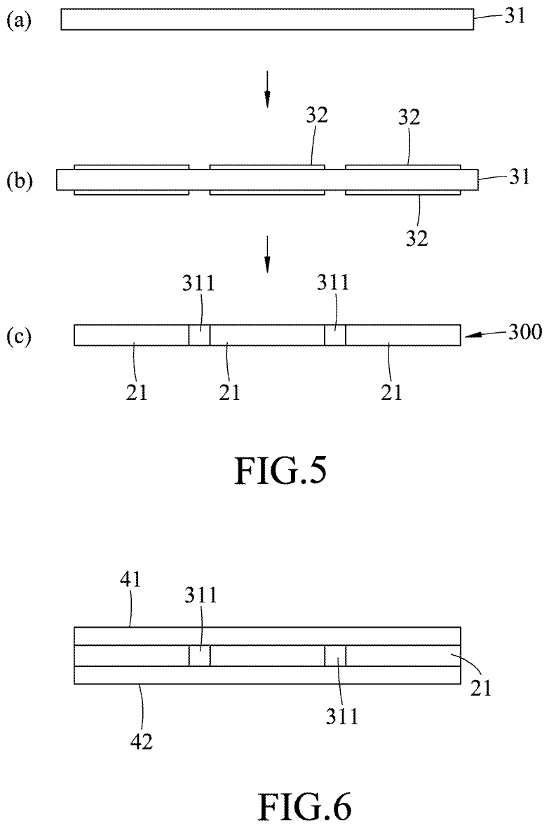

In step (A), referring to FIG. 4 and FIG. 5(a), a foil sheet 31 made of an electrically conductive material having a predetermined resistance value is provided.

In step (B), referring again to FIGS. 2, 4 and 5, a plurality of slits 311 which penetrate through the foil sheet 31 and which are arranged in multiple longitudinal and transverse rows are formed, so as to define a patterned foil sheet 300. In this embodiment, as shown in FIGS. 5(b) and 5(c), two photoresists layers 32 are first disposed on two opposite surfaces of the foil sheet 31, and are then etched inwardly at predetermined positions from outer surfaces thereof using photolithography to partially remove the photoresist layers 32 and the foil sheet 31, so as to form the slits 311, followed by removing the photoresist layers 32 from the foil sheet 31, thereby obtaining the patterned foil sheet 300. The patterned foil sheet 300 includes a plurality of resistor blanks 21 arranged in a matrix array, a plurality of connecting regions 314 situated at intersections of the longitudinal and transverse rows, and a framing strip 313 that loops around the resistor blanks 21, the slits 311, and the connecting regions 314. The slits 311 aligned in each of the longitudinal and transverse rows are spaced apart from each other at intersections of the longitudinal and transverse rows. The resistor blanks 21 are connected to each other by the connecting regions 314 and the framing strip 313.

In step (C), referring back to FIG. 2, in combination with FIG. 6, a first photoresist film 41 and a second photoresist film 42 are respectively bonded to a top surface and a bottom surface of the patterned foil sheet 300 so as to completely cover two opposite top and bottom surfaces of the resistor blanks 21.

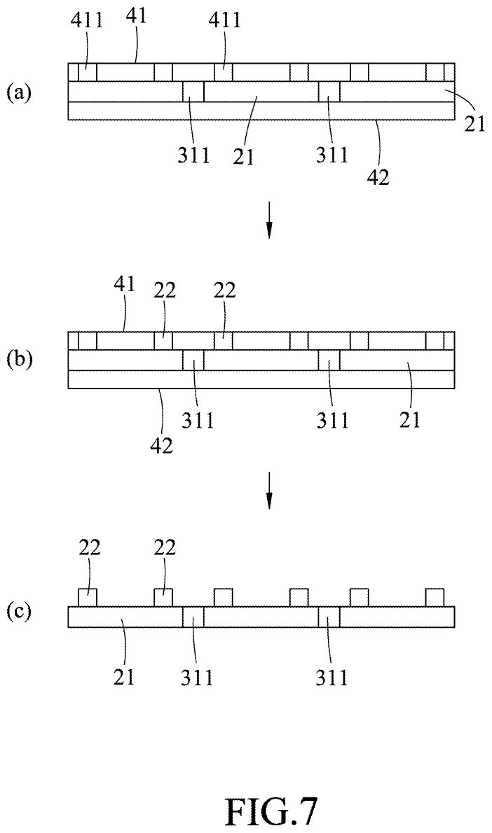

In step (D), referring again to FIG. 2, in combination with FIG. 7(a), a plurality of holes 411 are formed in the first photoresist film 41 such that the holes 411 expose top surfaces of the resistor blanks 21. As shown in FIG. 7(a), two of the holes 411 are respectively formed in a spaced apart manner by photolitography at two predetermined locations in each of multiple regions of the first photoresist film 41 respectively overlying the resistor blanks 21.

In step (E), referring back to FIG. 2, in combination with FIG. 7(b), a plurality of protruding blocks 22 made of an electrically conductive material that has a predetermined resistance value are formed in the holes 411 such that the protruding blocks 22 filling the holes 411 are connected to the top surfaces of the resistor blanks 21. In this embodiment, the protruding blocks 22 are formed by a process selected from the group consisting of electroplating, coating, printing, and combinations thereof. It should be noted that, insteps (D) and (E), the second photoresist film 42, which is firmly attached to the patterned foil sheet 300, can avoid peeling off from the patterend foil sheet 300 and can serve as flexible supporting structure to provide sufficient support for the patterned foil sheet 300.

In step (F), referring again to FIG. 2, in combination with FIG. 7(c), the first photoresist film 41 and the second photoresist film 42 are removed from the patterned foil sheet 300 so as to expose the resistor blanks 21. The first photoresist film 41 and the second photoresist film 42 may be removed easily and effectively using a solvent (e.g., a photoresist stripper), which will not cause physical damage to the resistor blanks 21 so as to avoid adversely affecting subsequent manufacturing steps.

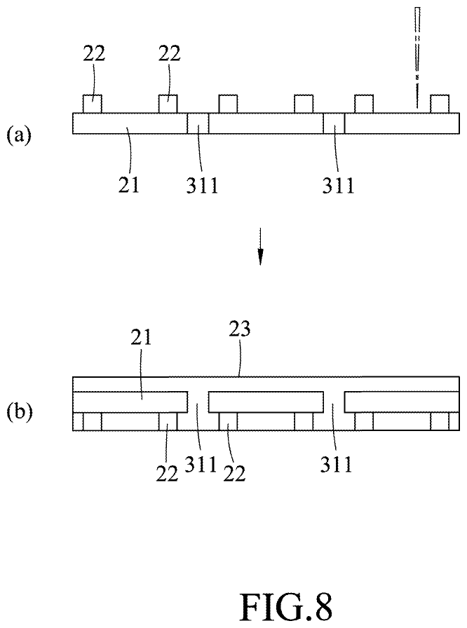

In this embodiment, after step (F), the top surface of each of the resistor blanks 21 which are not covered by the protruding blocks 22 are trimmed using laser (see FIG. 8(a)), so that the resistor blanks 21 are conferred with selected properties, e.g., a specific electrical resistance value.

In certain embodiments, after step (F), some of the protruding blocks 22 thus formed are not coplanar with side surfaces of the resistor blanks 21 (see FIGS. 7(c) and 8(a)), and thus, after the abovementioned step of trimming the top surfaces of the resistor blanks 21, parts of the resistor blanks 21 in proximity to the protruding blocks 22 may be removed by a dicing process so that the protruding blocks 22 are arranged to be coplanar with side surfaces of the resistor blanks 21, and the slits 311 are widened (see FIG. 8(b)).

In step (G), referring back to FIG. 2, in combination with FIG. 8(b), the patterned foil sheet 30 and the protruding blocks 22 are encapsulated using an encapsulating material 23 such that the encapsulating material 23 covers the top and bottom surfaces of the resistor blanks 21 without covering outer surfaces of the protruding blocks 22. In this embodiment, parts of the encapsulating material 23 formed by hot pressing are filled in the slits 311, and the encapsulating material 23 covering the resistor blanks 21 has a thickness equal to a height of each of the protruding blocks 22 formed on the resistor blanks 21, such that the encapsulating material 23 is flushed with the protruding blocks 22 so as to expose outer surfaces of the protruding blocks 22.

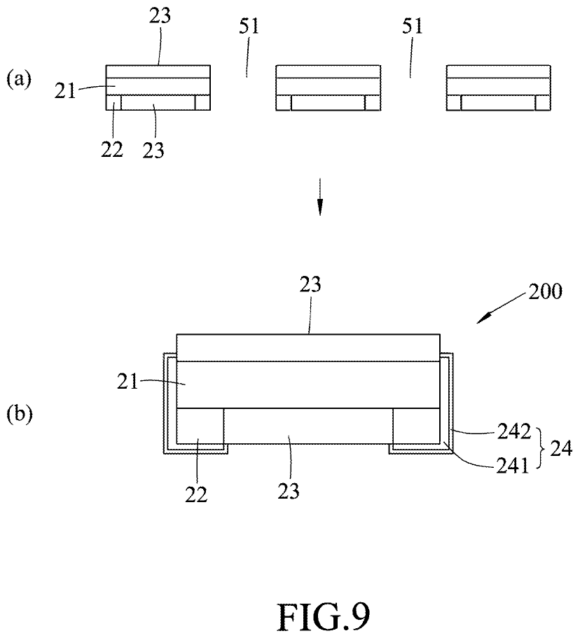

In step (H), referring again to FIG. 2, in combination with FIG. 9(a), a cutting process is performed to remove parts of the encapsulating material 23 extending along intersecting cutting lines 51 that pass through the slits 311, the connecting regions 314 and the framing strips 313 so as to obtain a plurality of individual resistor blanks 21 that are separated from one another, thereby exposing two opposite side surfaces of each of the individual resistor blanks 21 and a side surface of each of the protruding blocks 22 formed on each of the resistor blanks 21.

In step (I), referring back to FIG. 2, in combination with FIG. 9(b), two external electrodes 24 are respectively formed on the protruding blocks 22 and on two opposite side surfaces of each of the individual resistor blanks 21, so as to obtain the miniature resistor 200 as shown in FIG. 3. In this embodiment, each of the two external electrodes 24 includes two metallic layers, i.e., a nickel metal layer 241 and a tin metal layer 242, which are formed by electroplating. In other embodiments, the external electrodes 24 may be formed by, but not limited to, sputtering, surface deposition, conductive layer bonding, etc.

In summary, by virtue of the method for mass-manufacturing of the miniator resistor 200 according to the present disclosure, the patterned foil sheet 300 can be supported by the second photoresist film 42 to avoid problems of possible structural insufficiency of the patterned foil sheet 300 during formation of the protruding blocks 22, and since the second photoresist film 42 can be easily removed by a solvent without causing physical damage to the resistor blanks 21, it will not adversely affect subsequent manufacturing steps and quality of the thus manufactured miniature resistor 200. In addition, the second photoresist film 42 having a soft texture can be firmly attached to each of the resistor blanks 21 so as not to be easily peeled off during subsequent steps of the manufacturing method, and thus, manufacturing yield of the miniature resistor 200 is greatly enhanced and manufacturing cost thereof is effectively reduced, thereby enabling mass-manufacturing of the miniature resistor 200.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the present disclosure has been described in connection with what is considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for mass-manufacturing of a miniature resistor, comprising the steps of:
(A) providing a foil sheet made of an electrically conductive material having a predetermined resistance value;
(B) forming a plurality of slits penetrating through the foil sheet and arranged in multiple longitudinal and transverse rows so as to define a patterned foil sheet, the patterned foil sheet including a plurality of resistor blanks arranged in a matrix array, a plurality of connecting regions situated at intersections of the longitudinal and transverse rows, and a framing strip that loops around the resistor blanks, the slits and the connecting regions, the slits aligned in each of the longitudinal and transverse rows being spaced apart from each other at intersections of the longitudinal and transverse rows, the resistor blanks being connected to each other by the connecting regions and the framing strip;
(C) bonding a first photoresist film and a second photoresist film respectively to a top surface and a bottom surface of the patterned foil sheet so as to cover the resistor blanks;
(D) forming a plurality of holes in the first photoresist film such that the holes expose top surfaces of the resistor blanks;
(E) forming a plurality of protruding blocks made of an electrically conductive material that has a predetermined resistance value in the holes such that the protruding blocks filling the holes are connected to the top surfaces of the resistor blanks;
(F) removing the first photoresist film and the second photoresist film from the patterned foil sheet so as to expose the resistor blanks;
(G) encapsulating the patterned foil sheet and the protruding blocks using an encapsulating material such that the encapsulating material covers the top and bottom surfaces of the resistor blanks without covering outer surfaces of the protruding blocks;
(H) performing a cutting process to remove parts of the encapsulating material extending along intersecting cutting lines passing through the slits, the connecting regions and the framing strip so as to obtain a plurality of individual resistor blanks that are separated from one another; and
(I) forming two external electrodes respectively on the protruding blocks and on two opposite side surfaces of each of the individual resistor blanks so as to obtain the miniature resistor.

2. The method as claimed in claim 1, further comprising a sub-step of trimming the top surface of each of the resistor blanks which is not covered by the protruding blocks using laser, so that each of the resistor blanks is conferred with a specific electrical resistance value.

3. The method as claimed in claim 1, wherein in step (D), the holes are formed in the first photoresist film by photolithography.

4. The method as claimed in claim 1, wherein in step (D), two of the holes are respectively formed in a spaced apart manner at two predetermined locations in each of multiple regions of the first photoresist film respectively overlying the resistor blanks.

5. The method as claimed in claim 1, wherein in step (E), the protruding blocks are formed by a process selected from the group consisting of electroplating, coating, printing, and combinations thereof.

6. The method as claimed in claim 1, wherein in step (G), the encapsulating material covering the resistor blanks has a thickness equal to a height of each of the protruding blocks formed on the resistor blanks.

7. The method as claimed in claim 1, wherein in step (H), two opposite side surfaces of each of the individual resistor blanks and a side surface of each of the protruding blocks formed on each of the resistor blanks are exposed after parts of the encapsulating material are removed.

8. The method as claimed in claim 1, wherein in step (I), each of the two external electrodes includes two metallic layers.
